(19) United States
(12) Patent Application Publication
(10) Pub. No.: US 2006/0038960 A1
(43) Pub. Date: Feb. 23, 2006

(54) Projection system

(75) Inventor: Hak-yong Kim, Kwachoon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/120,325

(22) Filed: May 3, 2005

(30) Foreign Application Priority Data
May 3, 2004 (KR) 2004-0031119

(51) Int. Cl. G03B 21/26

(52) U.S. Cl. 353/30

(57) ABSTRACT

A projection system includes a plasma panel emitting light by discharging a gas; a panel driver driving the plasma panel; an illuminator focusing the light emitted from the plasma panel and converted into uniform parallel light; a display element visualizing an image with the light provided by the illuminator; and a projector projecting the image visualized by the display element to a screen at an enlarged scale.

### CROSS-REFERENCE TO RELATED APPLICATIONS

This application claims the benefit of Korean Patent Application No. 2004-31119, filed May 3, 2004, in the Korean Intellectual Property Office, the disclosure of which is incorporated herein by reference.

### BACKGROUND OF THE INVENTION

1. Field of the Invention

The present invention relates to a projection system and, more particularly, a projection system improved in its function and structure by employing a plasma panel as a light source.

2. Description of the Related Art

In general, a projection system projects an image visualized by a display element to a large screen. The project system comprises a light source that emits light, an illuminator focusing the light emitted from the light source, a display element visualizing the light from the illuminator as an image, and a projector lens projecting the image visualized by the display element to a screen.

The projection system may be classified as a front projection system or a rear projection system depending on the direction of projection of the image to the screen. The front projection system, for example, is provided in front of the screen and projects the image from a location in front of the screen, whereas the rear projection system is provided behind the screen and projects the image from a location behind the screen.

In addition, these projection systems are variously classified depending on the display element visualizing the light. A CRT (Cathode-Ray Tube), an LCD (Liquid Crystal Display) and an LCOS (Liquid Crystal On Silicon) are commonly used as the display element, and recently, a DMD (Digital Micromirror Device) element which embodies a plurality of micro mirrors by employing MEMS (Micro Electro Mechanical System) technology has been developed and is in use.

Most of these conventional projection systems employ an arc lamp emitting white light as a light source, and accordingly, require a ballast to light the arc lamp. In addition, a color wheel is provided in front of the light source to divide the white light generated by the light source into red, green and blue colors, and a driving motor is provided to drive the color wheel at a high speed.

Here, in the conventional projection systems, the light source emits the white light and the color wheel divides the white color into red, green and blue colors, an illuminator focuses light of red, green and blue colors, the display element visualizes the focused light into an image, and the projector lens projects the image to the screen at an enlarged scale.

However, the structure of these conventional projection systems is complicated because the light source emits the white light by employing an arc lamp which requires additional devices such as a ballast for driving the arc lamp, a color wheel (or a color filter) for dividing the white light into red, green and blue colors, and a driving motor for driving the color wheel, etc. Moreover, the driving motor drives the color wheel at a high speed which results in noise.

Therefore, the purpose of the present invention is to provide a projection system with a simple structure producing less noise.

### SUMMARY OF THE INVENTION

Accordingly, it is an aspect of the present invention to provide a projection system which is simplified in structure and prevents noise.

The foregoing and/or other aspects of the present invention are also achieved by providing a projection system comprising a plasma panel emitting light by discharging a gas; a panel driver driving the plasma panel; an illuminator focusing the light emitted from the plasma panel and converted into uniform parallel light; a display element visualizing an image with the light provided by the illuminator; and a projector projecting the image visualized by the display element to a screen at an enlarged scale.

According to an aspect of the present invention, the plasma panel emits light of red, green, and blue colors or combination of at least two of them.

According to an aspect of the present invention, the plasma panel comprises a front substrate to which a first electrode is applied; a rear substrate, corresponding to the front substrate, to which a second electrode is applied; a plurality of fluorescent-substance-coated partition walls forming a plurality of discharging spaces by partitioning the front substrate and the rear substrate in order to inject discharging gas thereto.

According to an aspect of the present invention, the rear substrate comprises a reflector provided to a rear surface thereof, reflecting the light emitted from the discharging spaces to the front substrate.

According to an aspect of the present invention, the reflector is plurally provided corresponding to the plurality of discharging spaces.

According to an aspect of the present invention, the display element comprises a DMD (Digital Micromirror Device) element.

According to an aspect of the present invention, the display element comprises an LCOS (Liquid Crystal On Silicon) element.

According to an aspect of the present invention, the display element comprises an LCD (Liquid Crystal Display) element.

### BRIEF DESCRIPTION OF THE DRAWINGS

The above and/or other aspects and advantages of the present invention will be readily apparent and appreciated from the following description of the exemplary embodiments taken in conjunction with the accompany drawings, of which:

FIG. 1 is a schematic view of a projection system according to a first embodiment of the present invention;

FIG. 2 is a schematically exploded perspective view of a plasma panel of the projection system described in FIG. 1;

FIG. 3 schematically shows a sectional view of the plasma panel of the projection system described in FIG. 1;

FIG. 4 is a schematic view of a projection system according to a second embodiment of the present invention; and

FIG. 5 is a schematic view of a projection system according to a third embodiment of the present invention;

### DETAILED DESCRIPTION OF ILLUSTRATIVE, NON-LIMITING EMBODIMENTS OF THE INVENTION

Reference will now be made in detail to illustrative, non-limiting embodiments of the present invention, examples of which are illustrated in the accompanying drawings, wherein like reference numerals refer to like elements throughout. The embodiments are described below in order to explain the present invention by referring to the figures.

### First Embodiment

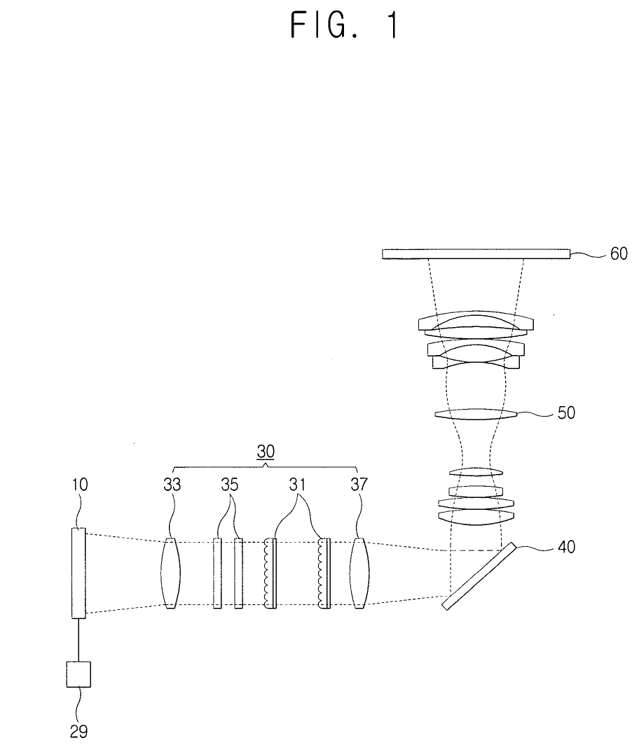

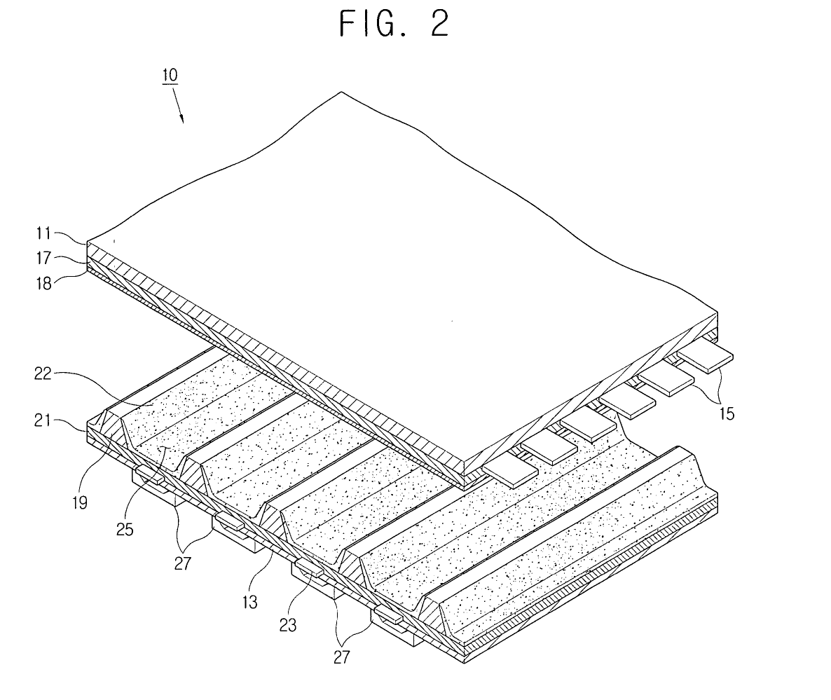

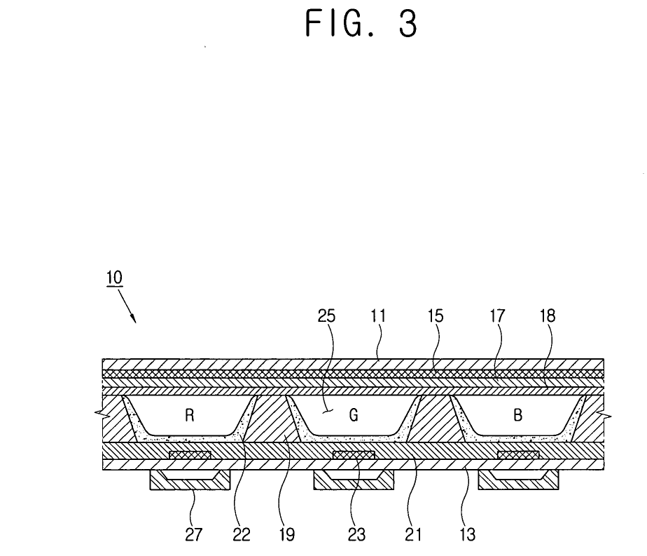

As shown in FIGS. 1 to 3, a projection system according to a first embodiment of the present invention comprises a plasma panel 10 as a light source emitting light; a panel driver 29 driving the plasma panel 10; an illuminator 30 focusing uniform parallel light into which the light emitted from the light source is converted; a display element 40 visualizing the light emitted from the illuminator 30 as an image; and a projector lens 50 projecting the image visualized by the display element 40 to a screen 60 at an enlarged scale.

The illuminator 30 comprises a condenser lens 33 converting the light emitted by the plasma panel 10 into parallel light, a polarizer 35 disposed next to the condenser lens 33, converting the light passed through the condenser lens 33 into linearly polarized light, a pair of fly eye lenses 31 disposed next to the polarizer 35, and a relay lens 37. Further, the condenser lens 33 and the polarizer 35 may be selectively provided to the illuminator 30 depending on a condition of the emitted light and the type of projection system.

The condenser lens 33 refracts the light emitted by the plasma panel 10 to provide parallel light to the polarizer 35. The polarizer 35 passes S polarized light which is in parallel with a penetrating shaft and reflects P polarized light which is vertical to the penetrating shaft.

The pair of fly eye lenses 31 enhances the uniformity of the light transmitted to the display element 40 by the arrangement of its lenses, and the relay lens 37 focuses the light passed through the fly eye lenses 31 to the display elements 40. The illuminator 30 may employ a light pipe instead of the fly eye lenses and the relay lens.

The light emitted by the plasma panel 10 is converted into uniform parallel light and focused by the illuminator 30, and transmitted to the display element 40.

According to the first embodiment of the present invention, the display element 40 is preferably, but not necessarily, a DMD (Digital Micromirror Device) element.

The DMD element 40 is formed by pixels having a plurality of micro mirrors arranged in two-dimensions. When an electrical current is applied to a memory element that is attached to each pixel, this current serves to tilt the mirrors to a first degree and/or a second degree and thereby, positions the mirrors at an ON state (reflecting light toward the projector lens) or at an OFF state (reflecting light away from the projector lens). In comparison with other type of display elements, such as an LCD (Liquid Crystal Display) or an LCOS (Liquid Crystal On Silicon), etc., the DMD element 40 creates a more life-like moving picture due to a speedy response of the element to the electrical current.

The projector lens 50 is plurally provided to project the image visualized by the DMD element 40 to the screen 60 at an enlarged scale.

The PDP (Plasma Display Panel) 10 excites a fluorescent substance by discharging gas and thus, emits light. The panel driver 29 drives the PDP 10 which emits light of red, green, or blue color or a combination of at least two them to the illuminator 30. The PDP 10 further comprises a front substrate 11 having a first electrode 15; a rear substrate 13 provided opposite to the front substrate 11, having a second electrode 23; and a plurality of fluorescent-substance-coated partition walls 19 forming a plurality of discharging spaces 25 into which discharging gas is injected.

The front substrate 11 is preferably, but not necessarily, a transparent glass substrate. The first electrode 15 is plurally provided on a bottom surface of the front substrate 11, and is extended perpendicularly to the longitudinal direction of the partition walls 19. The first electrode 15 is preferably, but not necessarily, a transparent electrode formed by decussation of a common electrode and a scanning electrode. On the bottom surface of the front substrate 11, a first dielectric layer 17 is preferably, but not necessarily, provided to cover the plurality of first electrodes 15. Further, a protection layer 18 made of magnesium oxide is provided on a bottom surface of the first dielectric layer 17 for the purpose of protection.

Similar to the front substrate 11, the rear substrate 13 is also preferably, but not necessarily, a glass substrate. The second electrode 23 is plurally provided in front of the rear substrate 13 and is extended in a direction parallel to the longitudinal direction of the partition walls 19, and preferably, but not necessarily, is an address electrode and is plurally provided in the surface of the rear substrate 13. In front of the rear substrate 13, a second dielectric layer 21 is preferably, but not necessarily, provided to cover the second electrode 23. Further, the plurality of partition walls 19 forming a plurality of discharging spaces 25 is provided in front of the second dielectric layer 21. The partition walls 19 are preferably, but not necessarily, provided between the second electrodes 23 which partition them. An inner side of the partition walls 19 and a front side of the second dielectric layer 21 are coated with a fluorescent substance 22 emitting red, green and blue colors. The discharging spaces 25 formed by the partition walls 19 between the front substrate 11 and the rear substrate 13 are filled with the discharging gas.

The panel driver 29 selectively applies voltage to the first electrode 15 and the second electrode 23 and, thereby, generates a discharge between the first electrode 15 and the second electrode 23. Accordingly, the fluorescent substance coated inside the discharging spaces 25 emits excitation light to the outside. Here, at least one red, green or blue color contained in the fluorescent substance 22 is selectively emitted and thus, light of red, green, or blue color or a combination of two of them is emitted to the illuminator 30. In other words, the panel driver 29 selectively excites more than two fluorescent substances 22 with red, green and blue color, and thus, the light of a combination of at least two of them can be emitted.

It is preferable, but not necessary, that the PDP 10 further comprises a reflector 27 provided at the bottom surface of the rear substrate 13, reflecting the light emitted from the discharging spaces to the bottom surface.

The reflector 27 is preferably, but not necessarily, provided plurally to correspond to each of the discharging spaces 25 in the rear substrate 13. It is preferable, but not necessary, that the reflector 27 is of a lens type to reflect the light emitted from each of discharging spaces 25 to the rear surface to the front substrate 11. However, the reflector 27 may be integrally provided with the rear surface of the rear substrate 13 to reflect the light emitted from all of the discharging spaces toward the rear surface to the front substrate 11. Here, the PDP 10 reflects the light emitted from the discharging spaces 25 toward the rear surface of the rear substrate 13 to the front substrate 11, and thereby reduces the loss of the emitted light.

With this configuration, the projection system according to the first embodiment of the present invention operates as follows:

The PDP 10 is actuated by the panel driver 29 and emits light containing red, green, and blue colors or a combination of at least two of them to the illuminator 30. In other words, the panel driver 29 drives the PDP 10 to illuminate the light of red, green or blue color or the combination of at least two of them. Then, the light emitted from the PDP 10 is focused, after being converted into uniform parallel light by the illuminator 30, and is transmitted to the DMD element 40. Then, the DMD element 40 visualizes an image, and the image is passed through the projector lens 50 and projected to the screen 60 at an enlarged scale.

Thus, the projection system according to the first embodiment of the present invention has a simple structure by employing the PDP 10 as the light source instead of an arc lamp emitting the white light that requires additional devices such as a color wheel extracting the while light and a driving motor actuating the color wheel, etc., and thereby prevents noise generated by the color wheel and the driving motor. Moreover, the projection system quickly responds to the discharge of the plasma driven by the panel driver 29, and thus, accurately adjusts to the timing of the light emitted from the PDP 10. In addition, when the reflector 27 reflects the light emitted from the PDP 10, the projection system reduces the loss of light which can occur.

### Second Embodiment

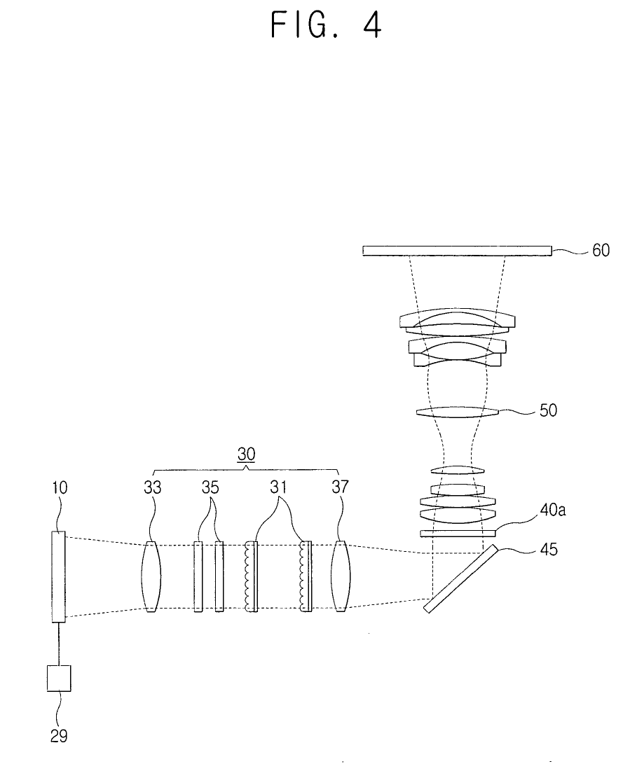

FIG. 4 schematically shows a projection system according to a second embodiment of the present invention. As shown therein, an LCD element 40a is employed as a display element whereas the first embodiment applies a DMD element as the display element.

The LCD element 40a is a device applying a characteristic of a liquid crystal that exists in a state similar to that of a liquid and similar to that of a solid at a certain temperature. If an electric charge is applied to liquid crystal molecules at this temperature, they are rearranged according to a direction of an electric field. Thus, the LCD element 40a is driven based on polarization theory, and the light emitted from the illuminator 30 passes therethrough and toward the projector lens 50. Further, a total reflection mirror 45 may be provided between the LCD element 40a and the illuminator 30.

With the above configuration, the projection system according to the second embodiment operates as follows.

The PDP 10 is driven by the panel driver 29, as in the first embodiment, to emit light of red, green or blue color or a combination of at least two of them toward the illuminator 30. Then, the light emitted from the PDP 10 is converted into uniform parallel light by the illuminator 30 and transmitted to the total reflection mirror 45 after being focused. The light is then reflected to LCD element 40a by the total reflection mirror 45, and the LCD element visualizes the reflected light as an image. The image is then transmitted to the projector 50 which projects the image to a screen at an enlarged scale.

Here, the projection system according to the second embodiment employs the PDP 10 as a light source, and accordingly, simplifies its structure and prevents noise, as in the first embodiment.

### Third Embodiment

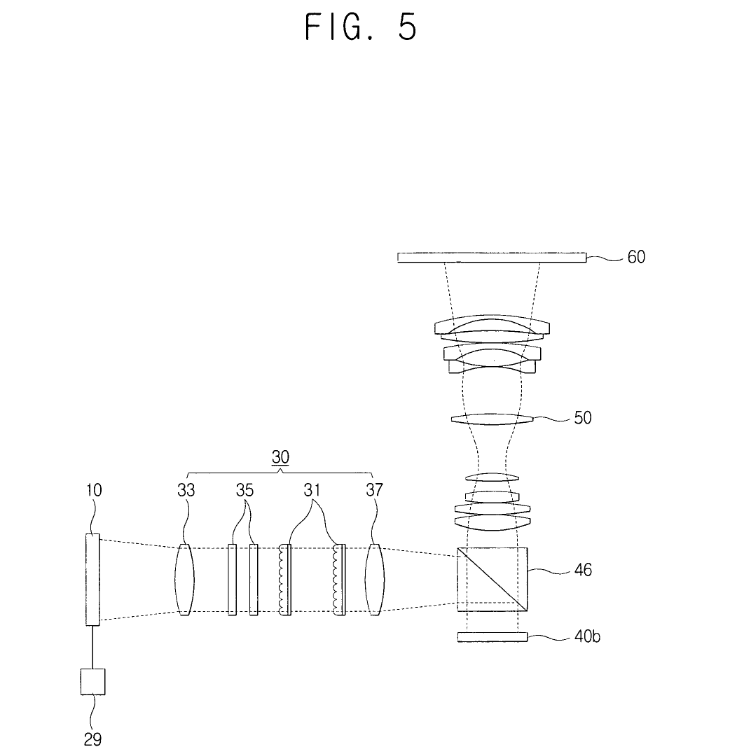

FIG. 5 illustrates a projection system according to a third embodiment of the present invention. As shown therein, an LCOS (Liquid Crystal On Silicon) element 40b is employed as a display element whereas the first embodiment employs a DMD element as the display element.

Unlike the permeable-type LCD element 40a, the LCOS element 40b is a reflective type element and is a microminiature display element applying a liquid crystal cell to a semiconductor substrate. A polarization beam splitter 46 is provided between the LCOS element 40b and the illuminator 30 to divide the light into S polarized light and P polarized light, wherein the polarization beam splitter 46 supplies the S polarized light to the LCOS element 40b.

With the above configuration, the projection system according to the third embodiment operates as follows.

The PDP 10 is driven by the panel driver 29, as in the first embodiment, to emit light of red, green or blue color or a combination of at least two of them toward the illuminator 30. Then, the light emitted from the PDP 10 is converted into uniform parallel light by the illuminator 30 and transmitted to the polarization beam splitter 46 after being focused. The polarized light is transmitted to LCOS element 40b and visualized as an image. Then, the image is transmitted to the projector 50 and projected to a screen 60 at an enlarged scale.

Here, the projection system according to the third embodiment employs the PDP 10 as a light source, and accordingly, simplifies its structure and prevents noise as in the first embodiment.

The projection system according to the foregoing embodiments of the present invention employs the PDP 10 as the light source and is a front projection type system. Thus, the projection system is provided in front of the screen and the image is projected from the front. However, the system may also be a rear projection type in which the projection system is provided behind the screen and the image is projected from behind.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A projection system comprising:
a plasma panel emitting light;
a panel driver driving the plasma panel;
an illuminator focusing the light emitted from the plasma panel and converting the light into uniform parallel light;
a display element visualizing an image with the light provided by the illuminator; and
a projector projecting the image visualized by the display element to a screen at an enlarged scale.

2. The projection system according to claim 1, wherein the plasma panel emits light of red, green or blue color or a combination of at least two of them.

3. The projection system according to claim 1, wherein the plasma panel comprises a front substrate to which a first electrode is applied; a rear substrate corresponding to the front substrate, to which a second electrode is applied; a plurality of fluorescent-substance-coated partition walls forming a plurality of discharging spaces by partitioning the front substrate and the rear substrate for receiving discharging gas.

4. The projection system according to claim 3, wherein the rear substrate comprises a reflector provided to a rear surface thereof, reflecting the light emitted from the discharging spaces to the front substrate.

5. The projection system according to claim 4, wherein the reflector is plurally provided corresponding to the plurality of discharging spaces.

6. The projection system according to claim 2, wherein the plasma panel comprises a front substrate to which a first electrode is applied; a rear substrate corresponding to the front substrate, to which a second electrode is applied; a plurality of fluorescent-substance-coated partition walls forming a plurality of discharging spaces by partitioning the front substrate and the rear substrate for receiving discharging gas.

7. The projection system according to claim 6, wherein the rear substrate comprises a reflector provided to a rear surface thereof, reflecting the light emitted from the discharging spaces to the front substrate.

8. The projection system according to claim 7, wherein the reflector is plurally provided corresponding to the plurality of discharging spaces.

9. The projection system according to claim 1, wherein the display element comprises a DMD (Digital Micromirror Device) element.

10. The projection system according to claim 1, wherein the display element comprises an LCOS (Liquid Crystal On Silicon) element.

11. The projection system according to claim 1, the display element comprises an LCD (Liquid Crystal Display) element.
